(19) United States
(12) Patent Application Publication
(10) Pub. No.: US 2005/0137937 A1
(43) Pub. Date: Jun. 23, 2005

(54) Method and apparatus for web-based label printing

(76) Inventors: Angela Njo, Shelton, CT (US); Dino Leovac, Allison Park, PA (US); Mikhail Chernyak, Shelton, CT (US)

Correspondence Address: Pitney Bowes Inc.;Intellectual Property & Technology Law Department, 35 Waterview Drive, P.O. Box 3000, Shelton, CT, 06484, US

(21) Appl. No.: 10/738,767

(22) Filed: Dec. 17, 2003

(51) Int. Cl. G06F 17/60

(52) U.S. Cl. 705/26

(57) ABSTRACT

A method and apparatus for printing a shipping label. The method includes transmitting request signals from a processor, via a network, to a remote electronic storage location, such as a database or a server. The request signals specify particular label requirements for a label. The label specification data is transmitted from the remote electronic storage location that meets the requirements of the request signals. The label specification data includes identifying data for a particular parcel carrier. The label specification data is transmitted from the processor to a selected printer and the printer prints a shipping label as a function of the label specification data, such that the identifying data is printed in a coded format. The contents of the remote electronic storage location are then updated.

### BACKGROUND OF THE INVENTION

1. Field of the Invention

The present invention relates generally to a method and apparatus for web-based label printing. More particularly, the present invention relates to carrier-approved and custom labels downloaded to a printer from a remote location.

2. Background Discussion

Many parcel carrier companies such as for example, United Parcel Service™ (UPS™), Federal ExpreSS™ (FEDEX™), United States Postal Service (USPS), DHL™, use shipping labels that contain information about the parcel. In order to increase the efficiency of the parcel shipping process, customers have the ability to print labels and affix the labels to the parcels prior to pick-up by the carrier. Thus, when the carrier personnel pick-up the parcel(s) from the customer location, they can scan the customer-generated labels and store the parcel data such as weight, destination, time of pick-up, class of service and other delivery parameters relating to the particular parcel. The generation and printing processes typically occur at the customer's location.

For example, U.S. Pat. No. 6,525,835, entitled, “Method and System For Parcel Label Generation”, issued Feb. 25, 2003, to Gulati, relates to a system for creating a label design for a parcel shipping or conformance label according to a specification of the label design and a specification of a target printer type. The system includes a label specification encoder into which a user provides inputs corresponding to a label design specification. The label specification encoder provides a so-called neutral language specification of the label, i.e., a specification suitable for automatic translation into control codes and printer commands for various types of label printer. The system also includes a label design generator, responsive to the neutral language specification, and further responsive to a target printer type provided as an input by a user. The label design generator provides a printer-specific label design. Capability for printing a two-dimensional bar code is provided, along with a capability for generating a check digit for a bar code. In addition, in some applications, the label specification encoder includes a copy field capability, for generating a parcel identifier from a package type indicator, a manufacturer identifier, and a package serial number. Finally, the label specification encoder enables field masking so as to create from a single stored field a plurality of printed fields separated by one or another delimiter. In some applications, there is also provided a printer application program interface (API), for printing a label with parcel-specific data, the printer API responsive to the printer-specific label design, and further responsive to the parcel-specific data.

U.S. patent application Publication US2003/0004830 published on Jan. 2, 2003 entitled, “Carrier and Package Delivery Desktop Tools” by Frederick, relates to users accessing shipping information pertaining to the shipment of parcels by selecting an action from a tool bar or menu associated with a text string in a document or spreadsheet either recognized by a Microsoft Office smart tag or highlighted by user. The actions from which to select include tracking, time in transit, shipping history, label generation, address validation, proof of delivery and rate and service selection. The necessary text is cut from the document or spreadsheet in which the user is working, opens or accesses databases, files, applications, websites, etc., as required to obtain the desired shipping information from a database accessible by the user, such as over a LAN or Internet connection. The data retrieved (including cutting, pasting, inserting or manipulating data and initiating actions such as dialing a phone number, generating a label or sending an e-mail) is processed and the results presented to the user in a message box or as an insert into the document or spreadsheet in which the user is working.

It would be advantageous to advance the state of the art to have a web-based printing solution to print thermal labels over a network for a multi-carrier system.

### SUMMARY OF THE INVENTION

In order to advance the state of the art and to provide a web-based printing solution that permits printing thermal labels over a network for a multi-carrier system, the present invention is directed to such a method and apparatus.

Accordingly, one embodiment of the present invention is directed to a method and apparatus for printing a shipping label. The method includes transmitting request signals from a processor, via a network, to a remote electronic storage location. The request signals specify particular label requirements. Next, the processor receives, via the network, label specification data from a remote storage location that meets the requirements of the request signals. The label specification data includes identifying data for a particular carrier. The label specification data is transmitted from the processor to a selected printer and the printer prints a shipping label as a function of the label specification data, such that the identifying data is printed in a coded format. The contents of the remote electronic storage location are then updated.

A further embodiment is the method and apparatus described above that further includes printing a thermal shipping label.

A further embodiment is the method and apparatus as described above that further includes receiving the label specification data, from the remote electronic storage location, at a browser that is associated with the processor and transmitting the label specification data from the browser to the processor.

A further embodiment is the method and apparatus as described above that further includes formatting the label specification data as a text-based-template.

A further embodiment is the method and apparatus as described above that further includes printing a bar code on the shipping label.

Yet another embodiment of the present invention is directed to a method and apparatus for printing a label. The method includes receiving, at a processor, via a network, program signals adapted to direct label print command signals, receiving, at the processor, via the network, label print command signals, retrieving a text-based template from a storage location, transmitting the label print command signals to a selected printer that is coupled to the processor; and printing a label as a function of the label print command signals and the text-based template.

Yet another embodiment is directed to a method, stored on a computer-readable medium, for printing a shipping label. The embodiment includes:
program code for transmitting request signals from a processor, via a network, to a remote electronic storage location, the request signals specifying particular label requirements;
program code for receiving, at the processor, via the network, label specification data from a remote storage location that meets the requirements of the request signals, the label specification data including identifying data for a particular carrier;
program code for transmitting the label specification data from the processor to a selected printer;
program code for printing a shipping label as a function of the label specification data, such that the identifying data is printed in a coded format; and
program code for updating the contents of the remote electronic storage location.

A further embodiment to the computer program described above includes program code for printing a thermal shipping label.

A further embodiment to the computer program described above includes program code for receiving the label specification data, from the remote electronic storage location, at a browser that is associated with the processor; and program code for transmitting the label specification data from the browser to the processor.

A further embodiment to the computer program described above includes program code for formatting the label specification data as a text-based-template.

A further embodiment to the computer program described above includes program code for printing a bar code on the shipping label.

Yet another embodiment of the present invention is directed to a computer program, stored on a computer-readable medium, for printing a label comprising:
program code for receiving, at a processor, via a network, program signals adapted to direct label print command signals;
program code for receiving, at the processor, via the network, label print command signals;
program code for retrieving a text-based template from a storage location;
program code for transmitting the label print command signals to a selected printer that is coupled to the processor; and
program code for printing a label as a function of the label print command signals and the text-based template.

A further embodiment to the computer program described above includes program code for modifying the label orientation, as a function of the text-based template.

A further embodiment to the computer program described above includes program code for pre-establishing characteristics of the text-based template.

A further embodiment to the computer program described above includes program code for modifying the pre-established characteristics of the text-based template.

### BRIEF DESCRIPTION OF THE DRAWINGS

Having thus described the invention in general terms, reference will now be made to the accompanying drawings, which are not necessarily drawn to scale, and wherein:

FIG. 1 shows a block diagram of the system of the present invention.

FIG. 2 shows an overview of a client/server environment of the present invention.

FIG. 3 shows a flowchart of steps to implement the present invention.

### DETAILED DESCRIPTION OF THE INVENTION

The present invention will now be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. The present invention includes all foreseeable equivalents as well as the best mode for carrying out the invention. Like numbers refer to like elements throughout.

The present invention permits users to print thermal shipping labels using a network, such as the Internet or other operatively coupled processors or computers. The printers that may be used typically have either a bitmap or ASCII based characteristics. A bitmap printer is essentially a graphic device that uses driver software that is associated with its port connection. The manufacturer of such printers typically suggests or supplies an application that can be used to design and print labels. For example, CoStar™ offers its EasySuite™ software.

An aspect of the invention is a labeling component that can run in a high volume server-based environment and the capability of label printing over the a network, such as the Internet. The invention supports graphic label images that can be rendered via HTML pages on the client monitor, or other user interface. The invention also has the ability for the component to support hardware specific ASCII-based commands that are typically downloaded to a label printer attached to the client computer.

Another aspect of the present invention is that the graphic label functionality enables generation of a plain paper label that is not client-side specific. This is particularly useful in small office/home office (SOHO) applications where a user may not need to obtain additional hardware since most SOHO users usually already own either a laser jet or ink jet printers. Thus, the present invention provides an inexpensive labeling solution that offers multi-carrier label support commonly associated with larger shipping applications.

The present invention also permits a hardware specific mode that provides a choice for users who like the convenience of a dedicated label (i.e. thermal) printer and tearing off a stocked label.

The label printing feature of the present invention is, for example, an ActiveX™ DLL written in Microsoft™ Visual Basic 6.0. The label printing may be used with a product-specific wrapper component that is mainly responsible for data mapping information from a database to the particular label properties. For instance for a personal shipping system (PSS), a PSSLabel COM component may be used to gather data required for the application and the appropriate label fields can be set prior to passing the entire fields and corresponding values to the processor. The wrapper component is typically, for example MTS/COM+ aware when used in an internet/intranet application, which then allows the component to take advantage of object pooling and just-in-time activation that MTS supports as well as for handling multi-threading issues.

The wrapper component utilizes the functionality offered from software, or other program code, to manipulate and create graphic images and to generate one-dimensional (I-D) and two-dimensional (2-D) bar code data or symbologies. The server environment typically utilizes a graphic image in a format acceptable to most browsers. One acceptable, and the most desired, format is the LZW-GIF compression algorithm, which has been standardized to some extent by CompuServe™.

When the present invention is used in a standalone application such as on a desktop computer, the generation and storage of the labels can be located anywhere on the computer for later retrieval. The unique file names for the labels can be randomly assigned, but for a shipping application it is preferred to assign the file name based on the unique package tracking number. Regardless of the carrier, the tracking number is intended to be unique for a certain period. Some carriers, such as Airborne™, require that vendor shipping systems guarantee that the tracking number is unique for as much as a year before it can be recycled. On the other hand, UPS™ requires that a tracking number be unique for at least two months.

Tracking numbers are typically composed of a number of data elements and check digit number. Typically, the business layer is responsible for maintaining unique labels. During a shipping transaction, this layer is responsible for assigning the package tracking number. At the time when a package label is being requested, the PSSLabel.DLL component serves as a product-specific label wrapper to extract information from the database and allows values to be assigned to the appropriate fields.

In a single server environment, accessing the labels in persistent storage is very similar to a standalone desktop operation. The access operation is very different for a high volume operation with clustered servers. Any ASP on one machine can serve a label request. Even for a single shipping session the pages can be serviced by any one of the available cluster. To enable sharing of the resulting package label, a dedicated directory on the clustered environment must be created such that any machine in the cluster can reference it.

A graphic label template is, for example, a proprietary text file that stores design information for a label. The graphic templates have a file extension (.WLB) for identification as being web-oriented label. The file defines the design characteristic of a label that features the ability to define, for example:
label dimension;
display orientation;
unit of measure for calculating density on a drawing element;
color specification (the default may be black on white, but can be expanded as needed) for drawing canvas;
field definition supported based on the object characteristic. Three basic types include: 1) dynamic text field; 2) dynamic barcode field; and 3) static label field.

The following discussion defines some of the definitions associated with each type of field object. The combined attributes that characterize each type of object are based attributes associated with Microsoft Window™ object and barcode attributes. The web label based (WLB) template allows these properties to be exposed for easier manipulation during the design phase of the label.

Non-graphic or printer code based label definitions have a file extension of *.DWN. The DWN extension identifies that the label to be generated is downloaded as a data stream on the client machine. DWN templates follow a predefined ASCII-based command language for a particular printer product. Hence, the command language for a Datamax™ printer would not be expected to be same for a different product line such as an Eltron™ printer.

In order to identify dynamic field variable, the template supports the special field delimiter, “˜”, to define a field. Each field begins and ends with “˜” character. Within the ˜ paired characters, a field's name, length, and visibility characteristics may be defined. Other characteristics such as those supported in the WLB template are typically not dynamically defined since the translation to the particular printer command language would be cumbersome. Since the label design has been predetermined, the command set can also be predetermined. The bulk of the processing involves parsing the template and replacing the ˜ delimited fields with the appropriate data at run-time.

The present invention extracts data from persistent storage such as a SQL database, manipulates the data for presentation, assigns data to the appropriate fields, and passes the data through a PSS label, which allows application specific mapping, to the LabelServer component for label processing. The component can then be accessed from an active server page to provide a label across the network/Internet.

There are two ways to that a label can be printed. One way is to use the browser File→Print menu which automatically prints the label to the default printer. No additional code is required on the client side to allow for printing. The user is notified that he should use the browser menu bar to complete the process.

For a client/server environment, a driver requirement can indicate that the server would need to download the appropriate driver on the client's machine when the client makes an initial labeling service request. In addition through client-side scripting on the HTML page, a component trust also be added to the client machine in order to process labeling requests and direct the information to drive particular printer drivers.

Thin client software may translate a stream and normalize it to remove escape commands that must be encoded for Internet exchange through a firewall. In contrast, an ASCII based printer does not require a driver as long as the port connection can handle pure ASCII commands. The commands themselves may be generic or specific to a printer. The printer's firmware has the responsibility to translate and manipulate the data being downloaded from the computer.

Another basic aspect of the label printers is the label width that a printer supports. While one printer can print a 4×6 inch label in one continuous stream, a printer with a 2 inch width limitation can support the same label via generating the label as three separate 2×4 inch labels. The latter situation has the overhead of printing side-ways and later requiring the customer to place the labels on the package in the carrier specified order.

The present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code embodied in the storage medium. More particularly, the present invention may take the form of web-implemented computer software. Any suitable computer-readable storage medium that is arranged to provide instructions to a computer or processor for execution may be suitable. Such a medium may take many forms, including but not limited to, non-volatile media, volatile media, and transmission media. Non-volatile media include, for example, optical or magnetic disks. Volatile media include dynamic memory, such as a computer's main memory.

Transmission media and transmission means include coaxial cables, copper wire and fiber optics. Transmission media can also take the form of acoustic or light waves, such as those generated during radio frequency (RF) and infrared (IR) data communications. Examples of common forms of computer-readable media include a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

The present invention is described below with reference to block diagrams and flowchart illustrations of systems, methods, apparatuses and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

As used herein the term module includes any software or hardware component that may be used alone or in conjunction with other modules. The transmission and reception of data from one module to another module is described in terms of communication.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

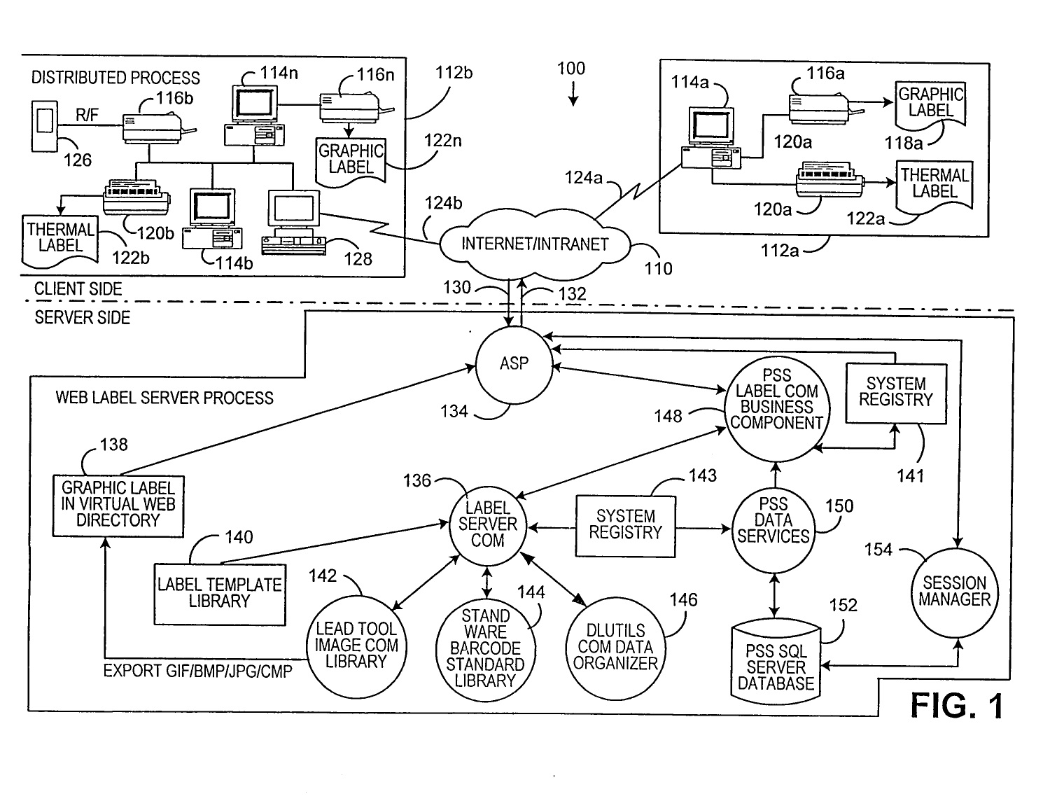

FIG. 1 shows a block diagram 100 of the system of the present invention. The system includes a plurality of client stations 112(a) and 112(b), a network 110, an application service provider (ASP), which could also be an Internet service provider (ISP), that is operatively coupled to a label server 136 and a PSS label component 148.

The client station 112(a) is operatively coupled by a browser 124(a) to network or Internet 110. This coupling enables data to be transmitted from the network/Internet 110 to the client station 112(a). The client station 112(a) includes a desktop personal computer (PC) 114(a), which is typically, for example, an Intel® Pentium® 4 processor at 2 GHz with a 533 MHz front side bus and 512 K L2 cache and a 60 GB hard drive. The PC 114(a) is operatively coupled to a laser printer 116(a) and an ASCII-based thermal printer 120(a). The laser printer 116(a) is arranged to print a graphic label 118(a) and the thermal printer 120(a) is arranged to print a thermal label 122(a). The labels 118(a) and 122(a) may be affixed to a letter, parcel, package or other article.

The client station 112(b) is operatively coupled by a browser 124(b) to the network or Internet 110. This coupling enables data to be transmitted from the network/Internet 110 to the client station 112(b). The client station 112(b) includes a workstation 128, which is for example, a processor or server that is coupled to a plurality of desktop personal computers (PC) 114(a) . . . (n) (where n is any suitable number). The desktop PC are typically, for example, Intel® Pentium® 4 processors at 2 GHz with a 533 MHz front side bus and 512 K L2 cache and a 60 GB hard drive. The PC 114(b) is operatively coupled to an ASCII-based thermal printer 120(a). The ASCII-based thermal printer 120(a) prints a thermal label 122(b). The desktop PC 114(n) is coupled to a plurality of laser printers 116(b) . . . (n). Laser printer 116(n) prints a graphic label 122(n) and printer 116(b) is coupled, typically through a radio frequency (R/F) link to a hand-held computer 126. The labels 122(b) and 122(n) may be affixed to a letter, parcel, package or other article.

The network/Internet 110 is also coupled to a server side via client cookies link 130 and Java Applet cookies 132. Links 130 and 132 connect network 110 to ASP 134, which is in bi-directional communication with PSSLabel COM module 148 and session manager module 154.

The PSSLabel COM module 148 is in bi-directional communication with label server 136, via a system registry 143, and receives input from PSS database 150. PSS database is in bi-directional communication with PSS SQL server database 152, which is also in bi-directional communication with session manager module 154.

The label server 136 is in bi-directional communication with label template module 140, image library module 142, barcode module 144, and data organizer module 146. Graphic label module 138 is in communication with ASP 134, as is system registry module 141. System registry module 141 is also in communication with PSSLabel module 148.

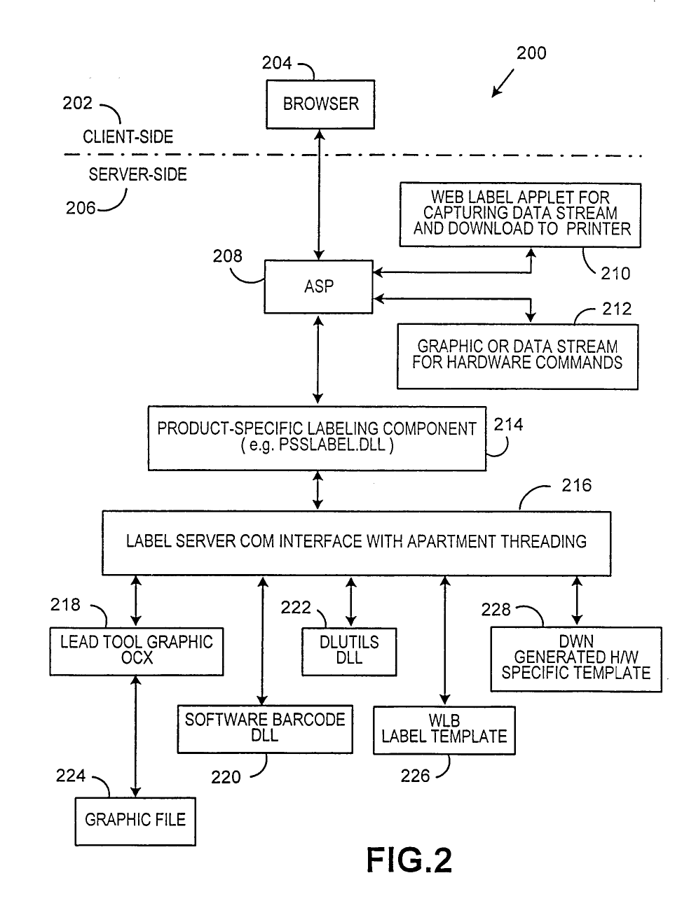

FIG. 2 shows an overview of a client/server environment 200 of the present invention, which includes client side 202 and server side 206.

Client side 202 includes browser 204, which may be any commercially-available browser.

Server side 206 includes ASP 208, which is in bi-directional communication with a product-specific label module 214 and graphic module 212 and web label applet module 210.

The product-specific label module 214 is in bi-directional communication with label server 216, which is in communication with graphics module 218, barcode module 220, utility module 222, .WLB label template module 226 and .DWN specific template module 228. Graphics module 218 is also in communication with graphic file module 224.

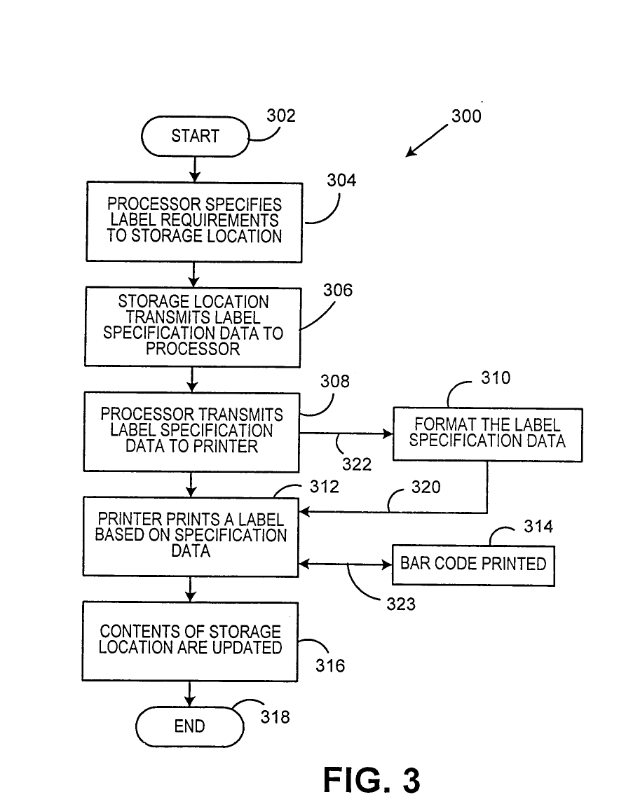

FIG. 3 shows a flowchart 30Q of steps to implement the present invention. Block 302 is a start block. Block 304 shows that a processor specifies label requirements to a storage location, which is typically a remote electronic storage medium. This transmission is typically accomplished over a computer network or the Internet or and Intranet.

Block 306 shows that the storage location retrieves appropriate label specification data and transmits it to the processor. This transmission is also typically accomplished over a computer network or the Internet or and Intranet.

Block 308 shows that the processor transmits the label specification data to a selected printer. Line 322 leads to block 310, which enables formatting of the label specification data according to a template, or other formatting mechanism. Line 320 leads to block 312.

Block 312 may be reached via block 308 or 310, depending on whether a template is implemented. Block 312 shows that the selected printer prints a label based on the label specification data, and possibly the format data. This data includes shipper data, destination address data, special service data, export control data, parcel weight data, tracking data and the like. This data may be printed in machine-readable and/or human-readable format. Bi-directional line 322 leads to block 314, which shows that a barcode and/or additional data is printed.

Block 316 shows that the contents of the remote storage location are updated and block 318 is an end block.

The present invention may utilize means for transmitting request signals from a processor. These means for transmitting may include hardwires, telephone lines, infrared transmission radio frequency transmission and any method of transmitting data from one location to another. The present invention also may utilize means for receiving, which include data ports at a terminal, telephone lines, hardwires, and other input modules.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for printing a shipping label comprising:
transmitting request signals from a processor, via a network, to a remote electronic storage location, the request signals specifying particular label requirements;
receiving, at the processor, via the network, label specification data from a remote storage location that meets the requirements of the request signals, the label specification data including identifying data for a particular carrier;
transmitting the label specification data from the processor to a selected printer;
printing a shipping label as a function of the label specification data, such that the identifying data is printed in a coded format; and
updating the contents of the remote electronic storage location.

2. The method as claimed in claim 1, wherein the printing step further comprises:
printing a thermal shipping label.

3. The method as claimed in claim 2, further comprising:
receiving the label specification data, from the remote electronic storage location, at a browser that is associated with the processor; and
transmitting the label specification data from the browser to the processor.

4. The method as claimed in claim 1, further comprising:
formatting the label specification data as a text-based-template.

5. The method as claimed in claim 1, wherein the printing step further comprises:
printing a bar code on the shipping label.

6. A method for printing a label comprising:
receiving, at a processor, via a network, program signals adapted to direct label print command signals;
receiving, at the processor, via the network, label print command signals;
retrieving a text-based template from a storage location;
transmitting the label print command signals to a selected printer that is coupled to the processor; and
printing a label as a function of the label print command signals and the text-based template.

7. The method as claimed in claim 6, further comprising:
modifying the label orientation, as a function of the text-based template.

8. The method as claimed in claim 6, further comprising:
pre-establishing characteristics of the text-based template.

9. The method as claimed in claim 8, further comprising:
modifying the pre-established characteristics of the text-based template.

10. An apparatus for printing a shipping label comprising:
means for transmitting request signals from a processor, via a network, to a remote electronic storage location, the request signals specifying particular label requirements;
means for receiving, at the processor, via the network, label specification data from a remote storage location that meets the requirements of the request signals, the label specification data including identifying data for a particular carrier;
the processor arranged to transmit the label specification data from the processor to a selected printer; and
a printer arranged to print a shipping label as a function of the label specification data, such that the identifying data is printed in a coded format,
wherein the processor is arranged to transmit data to update the contents of the remote electronic storage location.

11. The apparatus as claimed in claim 10, wherein the printer is arranged to print a thermal shipping label.

12. The apparatus as claimed in claim 11, further comprising a browser, associated with the processor, the browser arranged to receive the label specification data, from the remote electronic storage location; and
the browser arranged to transmit the label specification data from the browser to the processor.

13. The apparatus as claimed in claim 10, wherein the processor
formats the label specification data as a text-based-template.

14. The apparatus as claimed in claim 10, wherein the printer is arranged to print a bar code on the shipping label.

15. A apparatus for printing a label comprising:
a processor arranged to receive, via a network, program signals that direct label print command signals;
the processor arranged to retrieve a text-based template from a storage location;
a plurality of printers, coupled to the processor such that the processor transmits the label print command signals to a selected one or more of the plurality of printers; and
the selected one or more of the plurality of printers arranged to print a label as a function of the label print command signals and the text-based template.

16. The apparatus as claimed in claim 15, wherein the printer is arranged to
modify the label orientation, as a function of the text-based template.

17. The apparatus as claimed in claim 15, wherein the characteristics of the text-based template are pre-established.

18. The apparatus as claimed in claim 17, wherein the pre-established characteristics of the text-based template are capable of modification.

19. A method, stored on a computer-readable medium, for printing a shipping label comprising:
program code for transmitting request signals from a processor, via a network, to a remote electronic storage location, the request signals specifying particular label requirements;
program code for receiving, at the processor, via the network, label specification data from a remote storage location that meets the requirements of the request signals, the label specification data including identifying data for a particular carrier;
program code for transmitting the label specification data from the processor to a selected printer;
program code for printing a shipping label as a function of the label specification data, such that the identifying data is printed in a coded format; and
program code for updating the contents of the remote electronic storage location.

20. The method as claimed in claim 19, further comprising:
program code for printing a thermal shipping label.

21. The method as claimed in claim 20, further comprising:
program code for receiving the label specification data, from the remote electronic storage location, at a browser that is associated with the processor; and
program code for transmitting the label specification data from the browser to the processor.

22. The method as claimed in claim 19, further comprising:
program code for formatting the label specification data as a text-based-template.

23. The method as claimed in claim 19, further comprising:
program code for printing a bar code on the shipping label.

24. A method, stored on a computer-readable medium, for printing a label comprising:
program code for receiving, at a processor, via a network, program signals adapted to direct label print command signals;
program code for receiving, at the processor, via the network, label print command signals;
program code for retrieving a text-based template from a storage location;
program code for transmitting the label print command signals to a selected printer that is coupled to the processor; and
program code for printing a label as a function of the label print command signals and the text-based template.

25. The method as claimed in claim 24, further comprising:
program code for modifying the label orientation, as a function of the text-based template.

26. The method as claimed in claim 24, further comprising:
program code for pre-establishing characteristics of the text-based template.

27. The method as claimed in claim 26, further comprising:
program code for modifying the pre-established characteristics of the text-based template.
